(19) United States
(12) Patent Application Publication
(10) Pub. No.: US 2013/0031009 A1
(43) Pub. Date: Jan. 31, 2013

(54) AD-HOC CASH DISPENSING NETWORK

(71) Applicants: Arjun Kapoor, San Francisco, CA (US); Nir Wakrat, Menlo Park, CA (US); Anthony Fai, Palo Alto, CA (US)

(72) Inventors: Arjun Kapoor, San Francisco, CA (US); Nir Wakrat, Menlo Park, CA (US); Anthony Fai, Palo Alto, CA (US)

(73) Assignee: Apple Inc., Cupertino, CA (US)

(21) Appl. No.: 13/193,546

(22) Filed: Jul. 28, 2011

(51) Int. Cl. G06Q 40/00

(52) U.S. Cl. 705/77; 705/39

(57) ABSTRACT

An ad-hoc cash-dispensing network that allows users to efficiently exchange cash is provided. The ad-hoc cash-dispensing network includes a cash-dispensing server, a network, and a plurality of client terminals that connect to the cash-dispending server through the network. The user of a client terminal sends a request for cash to the cash-dispensing server. The request for cash includes the location of the client terminal. Based on this location, the cash-dispensing server locates one or more other users that are close/proximate to the requesting user and verifies that at least one of these proximate users is willing and able to provide the requested amount of cash. Following the transfer of cash between the parties, the requesting user's account is charged for the service while the providing user's account is credited for the service.

### BACKGROUND

An embodiment of the invention generally relates to a system and method for transferring cash between users of an ad-hoc cash-dispensing network. Other embodiments are also described.

Most businesses accept payment through credit, check, or other forms of non-direct cash payments. There are many benefits for consumers to use credit cards and checks in contrast to paying directly with cash. For example, credit cards offer rewards programs, fraud/theft protection, extended warranties on products purchased, etc. The proliferation of credit cards, checks, and other forms of non-direct cash payments has resulted in many people not carrying any cash or very small quantities of cash in their everyday lives.

However, there are often situations where cash payments are necessary. For example, some smaller businesses do not accept payment with credit cards because of the charges the proprietor of the business must pay to the credit card companies. Accordingly, there is a need for a cash-dispensing network that allows users to exchange cash as needed.

### SUMMARY

An embodiment of the invention provides an ad-hoc cash-dispensing network that allows users to efficiently exchange cash. The ad-hoc cash-dispensing network includes a cash-dispensing server, a network, and a plurality of client terminals that connect to the cash-dispensing server through the network. In one embodiment, a user of a client terminal sends a request for cash to the cash-dispensing server. The request for cash identifies the location of the client terminal. Based on this identified location, the cash-dispensing server locates one or more other users that are close or are proximate to the requesting user and verifies that at least one of these proximate users is willing and able to provide the requested amount of cash. Following the transfer of cash between the parties, the requesting user's account is charged for the service while the providing user's account is credited for the service. In one embodiment, in addition to the amount of cash, the requesting user is charged a service fee for the cash transfer. The service fee may be split between the providing user and the administrators of the ad-hoc cash-dispensing network.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 shows an ad-hoc cash-dispensing network in which an embodiment of the invention operates.

FIG. 2 shows a method of transferring cash using the ad-hoc cash-dispensing network.

FIG. 3a shows an example cash transferring application running on a client terminal of a requesting user.

FIG. 3b shows an example cash transferring application running on a client terminal of a proximate user (i.e. providing user).

FIG. 3c shows a user the client terminal displaying a map including locations of requesting and proximate users.

FIG. 4 shows a user interface of a cash transferring application that allows a user to set predefined rules for automatically sending a response to a cash request.

FIG. 5 shows an ad-hoc cash-dispensing system that may perform the method of transferring cash shown in FIG. 2.

### DETAILED DESCRIPTION

Several embodiments of the invention with reference to the appended drawings are now explained. While numerous details are set forth, it is understood that some embodiments of the invention may be practiced without these details. In other instances, well-known circuits, structures, and techniques have not been shown in detail so as not to obscure the understanding of this description.

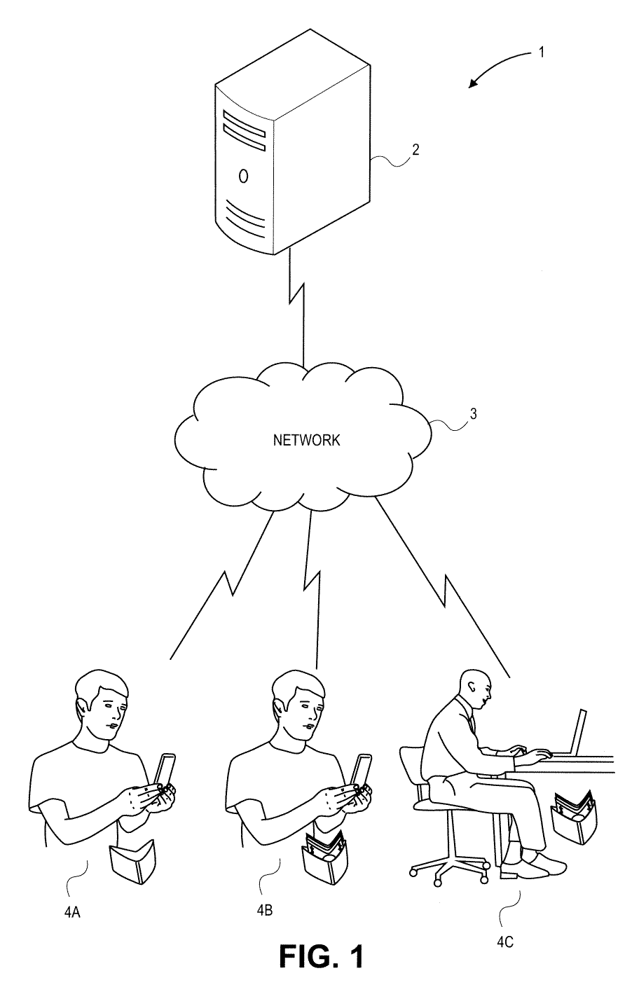

FIG. 1 shows an ad-hoc cash-dispensing network 1 in which an embodiment of the invention operates. The ad-hoc cash-dispensing network 1 includes a cash-dispensing server 2, a network 3, and client terminals 4. Each of these elements will be described below by way of example.

The network 3 may be composed of multiple smaller networks and may be capable of using various communication standards, protocols and technologies. The communications standards, protocols and technologies, may include Global System for Portable Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (WiFi) (e.g., IEEE 802.11a, IEEE 802.11b, IEEE 802.11g and/or IEEE 802.11n), Wi-MAX, LTE Advanced, or any other similar communication protocol, including communication protocols not yet developed as of the filing date of this document.

A client terminal 4 may be a desktop computer, a laptop computer, a netbook computer, a personal digital assistant, a cellular telephone, a mobile smart phone, an entertainment system, or other similar computing platform (generically referred to here as a “computer”). For example, a terminal 4 may be an iPhone™ device, iPad™ device or an iPod™ device by Apple Inc. of Cupertino, Calif. The client terminals 4, associated with respective users 4a, may communicate with the cash-dispensing server 2 through the network 3 using either a dedicated application or a web browser running on each of the client terminals 4. For example, each of the client terminals 4 may run the Safari™ web browser provided by Apple, Inc. of Cupertino, Calif. The web browser allows users to access a website associated with the cash-dispensing server 2 over the network 3. Accordingly, a client terminal 4 may include a network interface capable of connection to the network 3 using appropriate communication standards, protocols and technologies, an Internet Protocol (IP) network software stack, and an application program that communicates with the server 2.

In one embodiment, a client terminal 4 may include a system for determining location. For example, as a portable device the client terminal 4 may include a Global Positioning System (GPS) transceiver that communicates with one or more GPS satellites to determine location of the client terminal 4. Alternatively or in addition to the GPS transceiver, a client terminal 4 may include a cellular triangulation system that determines the location of the client terminal 4 based on its proximity to cellular towers. The location may be a street address, a set of longitude and latitude values, a distance from a landmark, or some other set of values to uniquely identify the location of the client terminal 4 on Earth. The system for determining location may be integrated into the client terminal 4 or it may be a peripheral device that is connected to the client terminal 4 through a wired or wireless peripheral bus (e.g. Universal Serial Bus (USB), IEEE 1394 (Firewire), iPod™ dock connector, Bluetooth, etc.).

The cash-dispensing server 2 may be a single computer, a set of one or more computers working in parallel, or any other suitable computing platform. In conjunction with the client terminals 4, the cash-dispensing server 2 assists in the transfer of cash between parties. The cash-dispensing server 2 will be described in further detail through description of its operation.

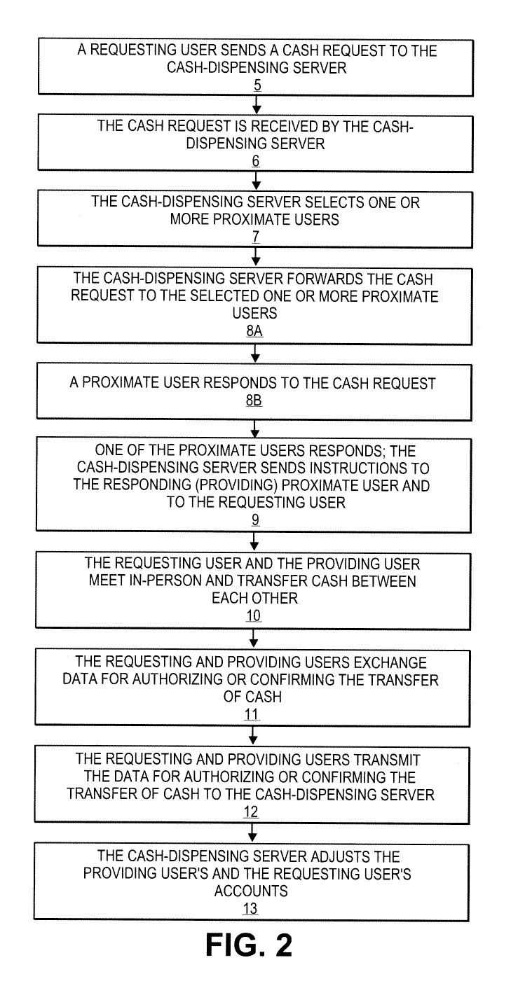

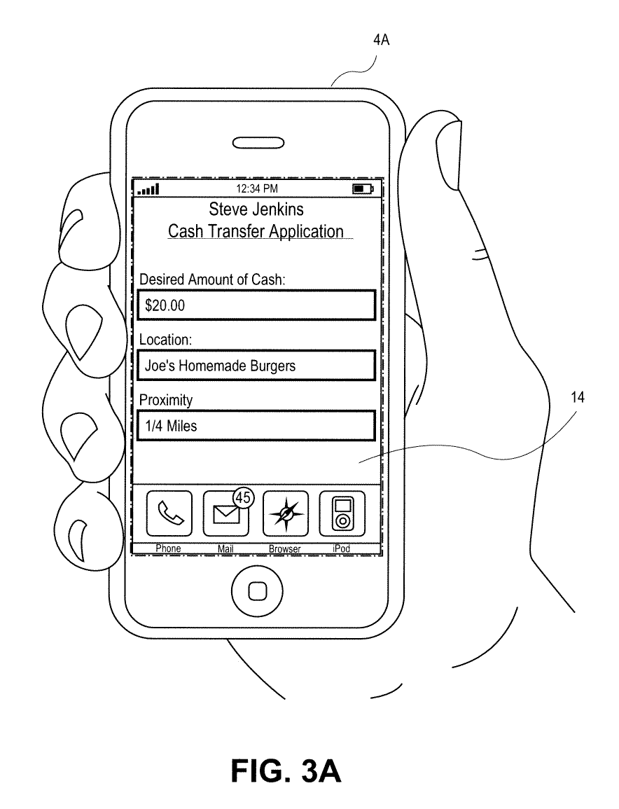

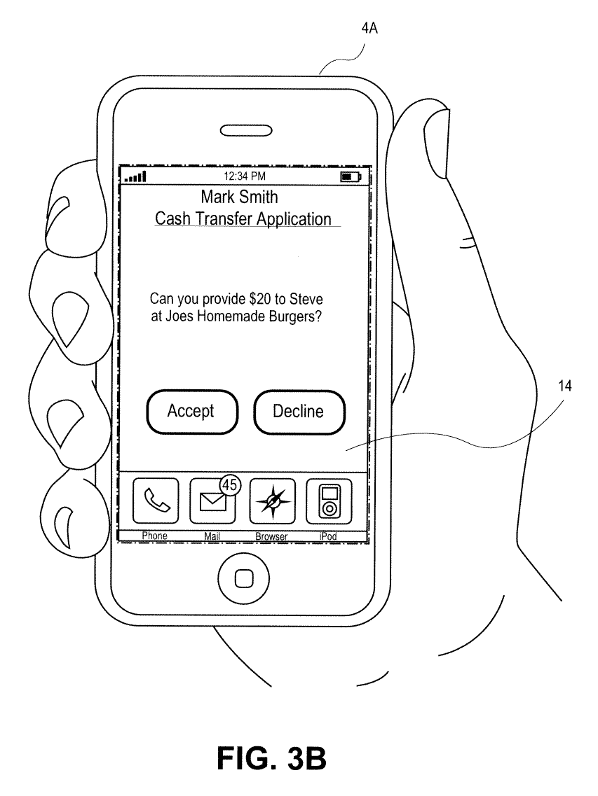

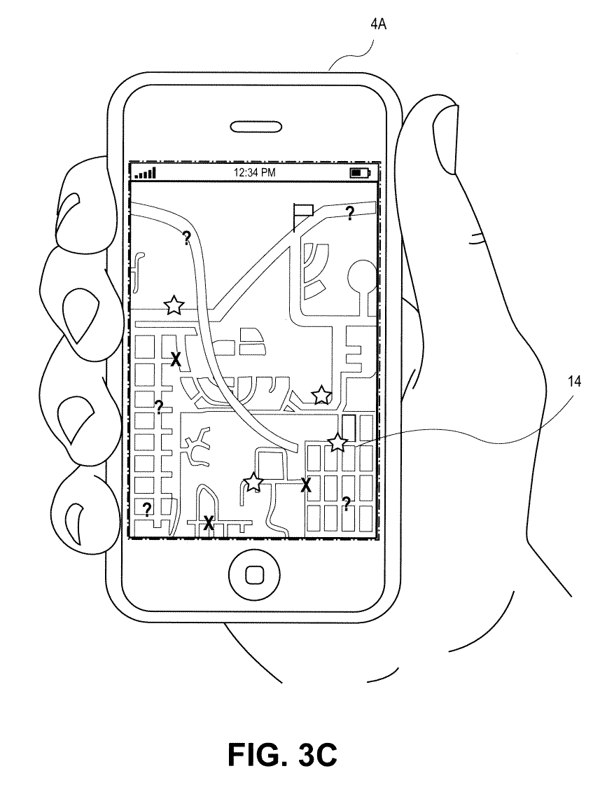

FIG. 2 shows a method of transferring cash using the ad-hoc cash-dispensing network 1. Each of the operations may be performed by the cash-dispensing server 2 and/or the client terminals 4. The method of transferring cash begins at operation 5 with a requesting user sending a cash request to the cash-dispensing server 2 for an amount of cash. The requesting user may use client terminal 4a to send the cash request. In one embodiment, the client terminal 4a is running a cash transferring application associated with the cash-dispensing server 2. FIG. 3a shows an example cash transferring application 14 running on the client terminal 4a (in this example having a touch-screen user interface). The requesting user logs into the cash-dispensing server 2 using the application 14 and selects a desired amount of cash using the user input fields provided by the cash transferring application 14. The login credentials used to login into the cash-dispensing server 2 may be associated with a social network the requesting user is part of (e.g. Facebook® or MySpace®). The application 14 retrieves the current location of the requesting user either automatically using a system for determining location embedded within or attached to the client terminal 4a, or manually, based on a location entry 15 filled-in by the requesting user. For example, the cash transferring application 14 may utilize a location provided by a GPS transceiver embedded in the client terminal 4a to determine location. Alternatively, the cash transferring application 14 may present a user with an interactive field, which allows the user to enter in a location address.

The cash transfer application 14 sends a cash request to the cash-dispensing server 2, in response to the send button being selected by the user. The cash request may include, for example, at least the desired amount entered by the requesting user, the current location of the client terminal 4a, the user credentials of the requesting user, etc. The request may be sent using various data formats including Extensible Markup Language (XML), Comma-separated values (CSV), Structured Data eXchange Formats, Abstract Syntax Notation One (ASN.1), Property list, Hypertext Markup Language (HTML), or similar formats. The request may be sent to the cash-dispensing server 2 over the network 3 using appropriate network protocols.

Although described above using a dedicated application running on the client terminal 4a, in other embodiments the user may log into and send a cash request to the cash-dispensing server 2 using a web-browser (running on the client terminal 4a). For example, the requesting user may access a web page associated with the cash-dispensing server 2 and enter appropriate information into corresponding user input fields provided by the web page. In one embodiment, the cash-dispending server 2 has web server functionality and is able to host a web page as described above.

Still referring to FIG. 2, at operation 6, the cash-dispensing server 2 receives the cash request generated by the client terminal 4a. As noted above, the cash-dispensing server 2 may be connected to the client terminal 4a through the network 3. Accordingly, the client terminal 4a wraps the cash request in the appropriate protocol such that it may be transported over the network 3 and received by the cash-dispensing server 2. For example, if the network 3 includes the Internet, the client terminal 4a may wrap the cash request in a set of TCP/IP wrappers prior to sending the request to the cash-dispensing server 2.

After receiving the request, the cash-dispensing server 2 processes the request. Processing of the request may begin by selecting one or more registered users that are proximately located to the requesting user (operation 7). In one embodiment the cash-dispensing server 2 sends a location demand to each user of the ad-hoc cash-dispensing network 1. Where the network 3 includes the Internet, the location demands may be transmitted over the network 3 using appropriate Internet protocols (e.g. TCP/IP). Alternatively, the location demands may be sent through a text messaging service (e.g. Short Message Service (SMS), Multimedia Messaging Service (MMS), Extended Messaging Service (EMS), etc.). In another embodiment, the sever 2 accesses a cellular network location register that is proximate to the requesting user's location. So that only those users whose mobile client terminals 4 are currently registered with that cellular network location register are sent the demand.

Upon receipt of the location demand, each user may respond to the server 2 with their current location. This response may be manually performed by the user or automatically performed by the user's associated client terminal 4. For example, the user may manually respond by logging into the cash-dispensing server 2 and entering their current location (e.g. an address, longitude and latitude, landmark, etc.). Alternatively, the location demand may be intercepted or received by the cash transferring application 14 which then automatically submits a response to the location demand, after prompting its user for permission to do, using a location provided by a system for determining location (e.g. a GPS transceiver) embedded within or attached to the client terminal 4a as described above.

Based on the locations received from each user of the client terminals 4, the cash-dispensing server 2 selects one or more users that are sufficiently proximate to the requesting user(FIG. 2, operation 7). This proximity criterion may be defined by the requesting user during the creation of the cash request. For example, the requesting user may set a distance (e.g. ¼ mile) that she is willing to travel to obtain the cash. FIG. 3a shows a user interface provided by the cash transferring application 14, which allows the user to enter a proximity distance. Based on this selected distance, the cash-dispensing server 2 finds users that are not more that than the selected distance away from the requesting user.

Upon finding one or more users that are sufficiently proximate to the requesting user, the cash-dispensing server 2 forwards the cash request to these selected one or more proximate users, and then awaits responses from the one or more proximate users at operation 8a. The cash requests may be forwarded over the network 3 using appropriate protocols (e.g. a sever-to-client Internet-based messaging protocol).

In one embodiment, the proximate users are also members of the same social network that the requesting user is part of. For example, the requesting user and the proximate users may both be part of Facebook®, MySpace®, or a similar social networking site. The requesting user may indicate in the cash request that proximate users must be part of a particular social network and have a particular degree of connection with the requesting user. For example, the requesting user may indicate that proximate users must be a second level friend on Facebook® (e.g. a friend of the requesting user or a friend of the requesting user's friend). This familiarity will increase the trust level between the requesting user and the proximate users.

In one embodiment, each proximate user is associated with a rating indicating the satisfaction or success rate of other users of the ad-hoc cash-dispensing network 1 during previous transactions with the proximate user. The requesting user may filter on these ratings to only send the cash request to proximate users with ratings above a defined level.

The one or more proximate users may access the cash request by logging into the cash-dispensing server 2 through the use of the cash transferring application 14 or the web browser running on a client terminal 4. The login credentials used to login to the cash-dispensing server 2 may be associated with a social network the proximate users' are part of (e.g. Facebook® or MySpace®). Upon accessing the cash request, the one or more proximate users may send either an affirmative response indicating they are willing/able to transfer the desired amount of cash to the requesting user or they may send a negative response indicating they are unwilling/unable to transfer the desired amount of cash to the requesting user at operation 8b. These responses may be sent by logging into the cash-dispensing server 2 through the use of the cash transferring application 14 or the web browser running on a client terminal 4. FIG. 3b shows a cash transferring application 14 running on a client terminal 4 of a proximate user. As shown in the FIG. 3b, the cash transferring application 14 presents the user with the cash request (e.g. “Can you provide $20 to Steve at Joes Homemade Burgers?”). The proximate user may either reply in the affirmative by selecting the “Accept” button, or she may reply in the negative by selecting the “Reject” button.

In one embodiment, the requesting user is presented with map indicating the locations of proximate users that have received the cash request. FIG. 3c shows a map with the location of the requesting user indicated with a flag and the locations of the proximate users indicated with a star, a question mark, or an “X”. This map may be included in the cash transferring application 14 running on a client terminal 4. In this example interface, the stars indicate proximate users that have accepted the cash request, question marks indicate proximate users that have not yet responded to the cash request, and “X” indicates proximate users that have declined the cash request. The map may update dynamically as proximate users respond to the requests. In one embodiment, this interface may be viewed by each of the proximate users as well as the requesting user.

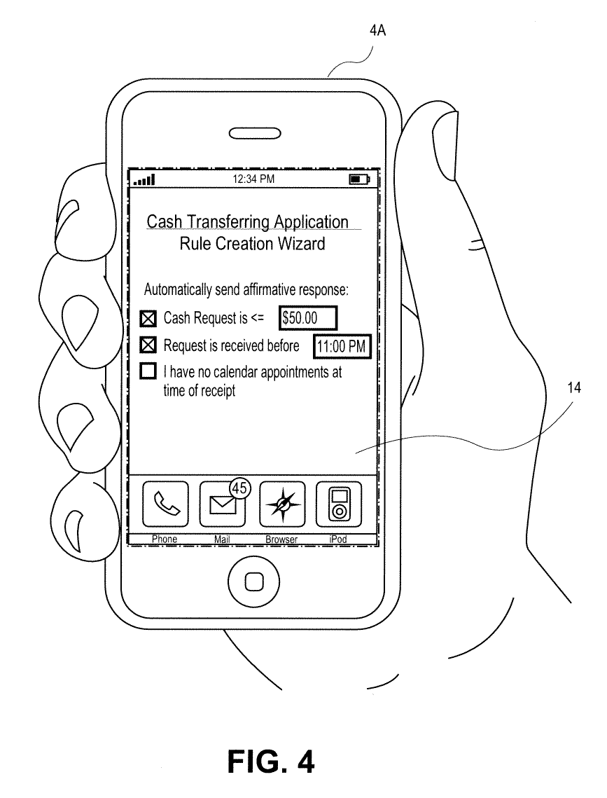

In one embodiment, the cash transferring application 14 may automatically send a response to the cash request based on a set of predefined rules. For example, a user may elect to accept every request for cash below $1. Alternatively, a user may elect to accept every request for cash within two miles from his/her current location. FIG. 4 shows a user interface of a cash transferring application 14 that allows a user to set predefined rules for automatically sending a response to the cash request. As shown, the user may create a set of rules based on attributes of the cash request, the time of day, a calendar status, etc.

In one embodiment, each requesting user is associated with a rating indicating the satisfaction or success rate of other users of the ad-hoc cash-dispensing network 1 during previous transactions with the requesting user. The requesting user may filter on these ratings to only receive cash requests from requesting users with ratings above a defined level. In one embodiment, proximate users may automatically accept cash requests from requesting users with ratings above a defined level.

Upon receiving an affirmative response to the cash request from a proximate user, the cash-dispensing server 2 sends instructions to the proximate user (hereinafter “providing user”) and the requesting user to perform the cash transfer at operation 9. In one embodiment, the instructions may include directions to a meeting place (e.g. directions to the current location of the requesting user, directions to the current location of the providing user, or equidistant location between the requesting and providing users), a meeting time, contact info of the other party (e.g. phone number or email address), a photo of the other party for easy identification, etc.

The instructions may also include data for authorizing or confirming the transfer of cash. For example, each of the requesting and providing users may be issued a unique alphanumeric code or a data token in the instructions. Accordingly, the alphanumeric code or data token of the requesting user is not the same as the alphanumeric code or data token given to the providing user. Use of the alphanumeric code and data token will be described in further details below.

Still referring to FIG. 2, at operation 10 the requesting user and the providing user meet at the common meeting place and the providing user transfers the requested amount of cash to the requesting user.

Upon transfer of the requested amount of cash, the users exchange data for authorizing or confirming the transfer of cash at operation 11. For example, the users may exchange an alphanumeric code or data token through a digital transmission between the client terminals 4. This digital transfer may be performed over the network 3 or through a local medium such as through Bluetooth or an infrared transfer mechanism included in the client terminals 4. The data for authorizing or confirming the transfer of cash may thereafter be sent to the cash-dispensing server 2 at operation 12. Alternatively, if one or both of the parties does not believe that the transfer of cash was correct (e.g. the providing user did not provide the full amount of cash), the users do not have to exchange data for authorizing or confirming the transfer of cash.

Upon receipt of the data for authorizing or confirming the transfer of cash, the cash-dispensing server 2 may adjust the providing user's and the requesting user's accounts at operation 13. The providing and requesting user's accounts may be apart of the ad-hoc cash-dispensing network 1 or they may be third party accounts. For example, the providing and requesting user's accounts may be third party traditional bank accounts, digital money and payment accounts such as those provided by an e-commerce business, or accounts created and fully operated by the ad-hoc cash-dispensing network 1.

In one embodiment, the GPS transceiver in the client terminals 4 of both the requesting and the providing user may be used to record the location of the users during the transaction. For example, the GPS transceiver in the client terminals 4 may each record their locations when the users exchange data for authorizing or confirming the transfer of cash at operation 11. The recorded locations of the users may be used as proof if disputes over the transaction arise.

In one embodiment adjustment of the providing user's and the requesting user's accounts includes depositing in the providing user's account the requested amount of cash and a reward amount for making the cash transfer. Adjustment may further include deducting from the requesting user's account the requested amount of cash, a service fee kept by the administrators of the cash-dispensing server 2, and the reward amount. For example, in a scenario in which $50 is requested and properly transferred between the requesting user and the providing user, the cash-dispensing server 2 may deduct from the requesting user's account $50 to cover the requested amount of cash, $5 to cover the service fee, and $3 to cover the reward amount for the providing user. Under this scenario the cash-dispensing server may deposit into the providing user's account $50 to cover the requested amount of cash and $3 to cover the reward amount for the providing user.

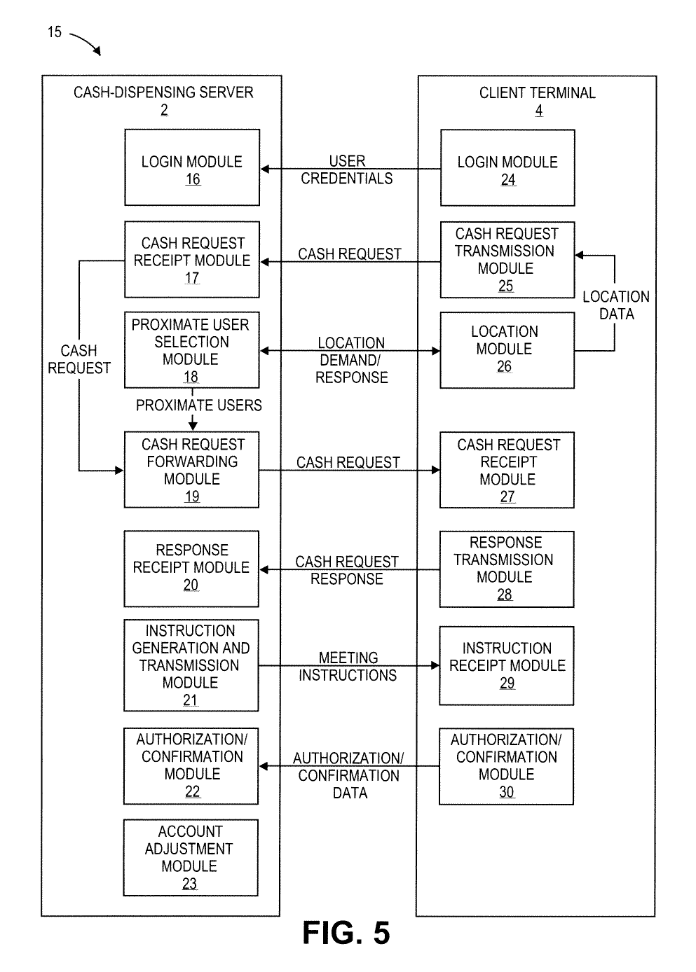

FIG. 5 shows an ad-hoc cash-dispensing system 15 that may perform the method of transferring cash shown in FIG. 2. The system elements may be parts of the cash-dispensing server 2 and the client terminals 4 as designated. Each of the elements of the ad-hoc cash-dispensing system 15 will be described by way of example.

Ad-hoc cash-dispensing system 15 includes a login module 16 on the cash-dispending server 2 and a login module 24 on the client terminals 4. Login modules 16 and 24 allow users of the client terminals 4 to login to the ad-hoc cash-dispensing network 1 using preexisting user credentials. In one embodiment, the login module 24 on the client terminal 4 allows the user to enter in user credentials and transfer this data to the login module 16 on the cash-dispensing server 2 over the network 3. Thereafter, the login module 16 verifies the user's credentials and ensures the user is authorized to use the ad-hoc cash-dispensing network 1. If a user does not have preexisting credentials, the login modules 16 and 24 may allow the user to register with the ad-hoc cash-dispensing system 15. Registration may include submitting user-specific items such as user name, phone number, address, bank account information, authorization to access the bank account, etc. The login modules 16 and 24 may be implemented as software components, e.g. as part of a server side application and the cash transferring application 14.

After successfully registering and logging into the ad-hoc cash-dispensing network 1 using login modules 16 and 24, the user is allowed to send cash requests to the cash-dispensing server 2 using cash request transmission module 25. The cash request transmission module 25 retrieves input from the user regarding a desired amount of cash. The transmission module 25 may additionally retrieve user input regarding the user's current location or may access the user's current location from location module 26. The location module 26 retrieves this information form a system for determining location integrated or otherwise coupled to the client terminal 4 as described above. Upon obtaining inputs regarding the desired amount of cash and the current location of the user, the cash request transmission module transmits the cash request to the cash-dispensing server 2 where the cash request is received by the cash request receipt module 17.

Upon receiving a cash request from a client terminal 4, the proximate user determination module 18 determines one or more users that are proximately located to the requesting user. As described above, this may be performed by sending location demands to each user of the ad-hoc cash-dispensing network 1. The location module 26 of each client terminal 4 receives the location demand and responds with their current location. In turn, the proximate user determination module 18 receives each of these responses from the location module 26 of each client terminal 4 and determines one or more users that are proximate to the requesting user.

Upon determining one or more proximate users, the cash request forwarding module 19, forwards the requesting user's cash request to each of the one or more proximate users. The forwarded cash requests are received by the cash request receipt module 27 of the client terminals 4 associated with the one or more proximate users such that they may be viewed by the one or more proximate users.

Based on the forwarded cash requests, each of the one or more proximate users may respond using response transmission module 28. The response transmission module may provide a set of user inputs to receive either an affirmative response to the cash request indicating they are willing/able to transfer the desired amount of cash to the requesting user or conversely may send a negative response indicating they are unwilling/unable to transfer the desired amount of cash to the requesting user. These responses are transmitted by the response transmission module 28 to the response receipt module 20 of the cash-dispensing server 2.

Upon receipt of an affirmative response from a user (hereinafter “providing user”), the instruction generation and transmission module 21 generates a set of instructions for facilitating the transfer of cash. In one embodiment, the instructions may include directions to a meeting place (e.g. directions to the current location of the requesting user, directions to the current location of the providing user, or equidistant location between the requesting and providing users), a meeting time, contact info of the other party (e.g. phone number or email address), a photo of the other party for easy identification, etc. Upon generation of the instructions, the instruction generation and transmission module 21 send the instructions to both the requesting user and the providing user. In one embodiment, the instructions are received by the instruction receipt module 29 of the providing and requesting user's client terminals 4 such that they may be used by the respective users.

Following the successful transfer of cash from the providing party to the requesting party, the authorization/confirmation module 30 on each of the requesting and providing terminals 4 may transfer a unique alphanumeric code or a data token to confirm that the cash transfer has been properly performed. The unique alphanumeric codes or data tokens are received by the authorization/confirmation module 22 and trigger the account adjustment module 23 to adjust the accounts of the requesting and providing users as described above.

To conclude, various aspects of a technique for transferring cash between users of an ad-hoc cash-dispensing network have been described. As explained above, an embodiment of the invention may be a machine-readable medium such as one or more solid sate memory devices having stored thereon instructions which program one or more data processing components (generically referred to here as “a processor” or a “computer system”) to perform some of the operations described above. In other embodiments, some of these operations might be performed by specific hardware components that contain hardwired logic. Those operations might alternatively be performed by any combination of programmed data processing components and fixed hardwired circuit components.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. It should be noted that the functions of the various modules in FIG. 5 may be managed or allocated differently, i.e. amongst a different collection of modules. For instance, the transfer and verification of user credentials may be allocated to different modules. The description is thus to be regarded as illustrative instead of limiting.

What is claimed is:

1. A method for transferring cash, comprising:
receiving, by a cash dispensing server, a cash request from a client terminal of a requesting party, wherein the cash request identifies the location of the requesting party and an amount of cash requested;
identifying, by the cash dispensing server, a providing party located near the requesting party;
sending, by the cash dispensing server, the cash request to a client terminal of the providing party;
receiving, by the cash dispensing server, an acceptance to the cash request from the client terminal of the providing party;
crediting a first amount to an account of the providing party; and
deducting a second amount from an account of the requesting party.

2. The method for transferring cash of claim 1, further comprising:
selecting a meeting location and time based on the locations of the requesting party and the providing party; and
transmitting the determined meeting location and time to the requesting and providing parties.

3. The method for transferring cash of claim 1, further comprising:
distributing a first digital certificate to the providing party; and
distributing a second digital certificate to the requesting party, wherein the first and second digital certificates are exchanged by the providing and requesting parties upon delivery of the amount of cash requested by the providing party to the requesting party.

4. The method for transferring cash of claim 3, further comprising:
transferring, by the requesting party, the first digital certificate to the cash dispensing server; and
transferring, by the providing party, the second digital certificate to the cash dispensing server.

5. The method for transferring cash of claim 1 wherein the second amount is larger than the first amount.

6. The method for transferring cash of claim 1, wherein the amount of cash requested in the cash request is less than the first amount.

7. The method for transferring cash of claim 1,
wherein the requesting party sends the cash request using a mobile electronic device,
wherein the location of the requesting party is determined using a GPS system integrated within the mobile electronic device.

8. The method for transferring cash of claim 1,
wherein the providing party sends the acceptance to the cash request using a mobile electronic device,
wherein the location of the providing party is determined using a GPS system integrated within the mobile electronic device.

9. The method for transferring cash of claim 1, wherein the accounts of the providing and requesting parties are external to the cash dispensing server.

10. A system for transferring cash, comprising:
a cash request receipt module for receiving a cash request from a requestor, wherein the request includes a current location of the requestor and a requested amount of cash;
a proximate user selection module for identifying locations of a set of one or more possible providers and selecting a first proximate provider from the set of possible providers;
a cash request forwarding module for forwarding the cash request to the first proximate provider; and
an account adjustment module for deducting a first amount from an account of the requestor and crediting a second amount to an account of the first proximate provider.

11. The system for transferring cash of claim 10, wherein the proximate user selection module selects the first proximate provider from the set of possible providers based on the proximity of the first proximate provider to the requestor.

12. The system for transferring cash of claim 11, further comprising:
a response receipt module for receiving a response to the cash request from the first proximate provider, wherein upon receipt of a rejection of the cash request from the first proximate provider, the response module directs the (1) proximate user selection module to select a second proximate provider from the set of possible providers and (2) the transfer module to forward the cash request to the second proximate provider.

13. The system for transferring cash of claim 10, further comprising:
a confirmation module for issuing a first digital certificate to the requestor and a second digital certificate to the first proximate provider and for receiving the first digital certificate from the first proximate provider and the second digital certificate from the requestor.

14. The system for transferring cash of claim 13, wherein upon receiving the first digital certificate from the first proximate provider and the second digital certificate from the requestor, the confirmation module directs the account adjustment module to deduct the first amount from the account of the requestor account and credit the second amount to the account of the first proximate provider.

15. The system for transferring cash of claim 10, further comprising:
an instruction generation module for generating instructions for transferring cash, wherein the instructions include a meeting location and a time to meet.

16. The system for transferring cash of claim 15, wherein the instructions also include contact information and pictures of the requestor and the first proximate provider.

17. An article of manufacture comprising:
a machine readable computer storage medium having stored instructions that program a mobile communications device of a providing party to:
receive a cash request that originated from a requesting party, wherein the cash request includes the location of the requesting party and an amount of cash requested,
send an acceptance to the cash request,
receive instructions for transferring cash between the providing party and the requesting party, wherein the instructions include a meeting location and a time to meet, and
send a digital certificate to a cash dispending server indicating the transfer of cash was successfully performed.

18. The article of manufacture of claim 17, further comprising:
send a current location of the providing party using a GPS system integrated within the mobile electronic device.

19. An article of manufacture comprising:
a machine readable computer storage medium having stored instructions that program a mobile communications device of a requesting party to:
send a cash request to a providing party, wherein the cash request includes the location of the requesting party and an amount of cash requested,
receive instructions for transferring cash between the providing party and the requesting party, wherein the instructions include a meeting location and a time to meet, and
send a digital certificate to a cash dispending server indicating the transfer of cash was successfully performed.

20. The article of manufacture of claim 19, further comprising:
send a current location of the requesting party using a GPS system integrated within the mobile electronic device.

21. A system for transferring cash, comprising:
a cash request receipt module for receiving a cash request from a requestor, wherein the request includes a current location of the requestor and a requested amount of cash;
a proximate user selection module for identifying locations of a set of one or more possible providers; and
a cash request forwarding module for forwarding the cash request to the set of one or more possible providers; and
a response receipt module for receiving a response to the cash request from the set of one or more possible providers.

22. The system for transferring cash of claim 21, further comprising:
a presentation module for displaying a map of the current location of the requestor and the locations of the set of one or more possible providers and the responses of the set of one or more possible providers to the cash request.

23. The system for transferring cash of claim 21, wherein the requestor and the one or more possible providers are part of a social network that is separate from the system for transferring cash.

24. The system for transferring cash of claim 21, further comprising:
orating module for receiving and storing ratings for the requestor and the possible providers based on their interactions in the system for transferring cash;
a filter module for filtering possible providers with ratings below a defined level; and
a transaction confirmation module for storing locations of the requestor and one of the possible providers upon the transfer of cash between the requestor and the one of the possible providers.
